(19) United States
(12) Patent Application Publication
(10) Pub. No.: US 2026/0228853 A1
(43) Pub. Date: Aug. 6, 2026

(54) SYSTEMS AND METHODS FOR IMAGE DETECTION IN OBSCURED OR DISTORTED ENVIRONMENTS

(71) Applicant: DejaVuAI Inc., Olalla, WA (US)

(72) Inventors: John Kessler, Olalla, WA (US); Fedor Kapoustine, Bellevue, WA (US)

(73) Assignee: DejaVuAI Inc., Olalla, WA (US)

(21) Appl. No.: 19/046,256

(22) Filed: Feb. 5, 2025

(51) Int. Cl. G06T 3/14; G06T 3/40; G06T 7/11; G06V 10/74; G06V 10/762

(52) U.S. Cl. CPC G06T 3/14; G06T 3/40; G06T 7/11; G06V 10/761; G06V 10/762

(57) ABSTRACT

Systems and methods for image detection in obscured and/or distorted environments are described. For example, the system may receive a first image. The system may generate a first topology pattern for the first image based on a first location of a first portion in the first image determined to comprise a first image characteristic. The system may compare the first topology pattern to a plurality of index topology patterns. The system may, based on comparing the first topology pattern to the plurality of index topology patterns, determine a confidence that the first image corresponds to an index image. The system may generate for display, on a user interface, a recommendation based on the confidence.

### BACKGROUND

Image processing is a field of computer science and engineering that focuses on analyzing, enhancing, and manipulating digital images to extract meaningful information or improve their quality. It involves applying various algorithms and techniques to transform an image for specific purposes, such as visual enhancement, data extraction, or efficient storage. As one practical application, image processing can play a significant role in finding missing minors. The process typically begins by analyzing photographs of the missing minor to extract key features such as facial structure, skin tone, and distinguishing characteristics like birthmarks or scars. These features are then encoded into a digital representation, often referred to as a facial template, which can be stored in databases for comparison. Surveillance footage, social media images, and feeds from public places like transportation hubs can be scanned using these templates, allowing for the automated detection of potential matches.

### SUMMARY

Systems and methods are described herein for novel uses and/or improvements to image processing, particularly for detecting people or objects in images. For example, conventional approaches to image processing used to detect a person or other objects in an image may employ algorithms like edge detection or segmentation to identify distinct regions or boundaries that correspond to people or objects. More robust approaches may use machine learning and deep learning techniques, such as Convolutional Neural Networks (CNNs). These models are trained on large datasets of labeled images, learning to recognize patterns associated with a person or object.

However, these conventional approaches struggle to accurately detect people or objects in images that are distorted or feature partial obscurations. For example, distortions, such as noise, blur, or changes in resolution, can obscure critical features like edges, textures, and shapes, which are essential for recognizing objects under these approaches. Similarly, when a person or object is partially obscured, key identifying features may be missing or fragmented, making it difficult for algorithms to form a complete representation. Conventional methods that rely on predefined features, edges, and/or segmentations fail in such cases because they depend heavily on clear, well-defined inputs. Even the advanced approaches like deep learning models, while more robust, will fail to an unfamiliarity with the distorted or obscured objects.

Systems and methods described herein overcome these limitations in the conventional approaches. For example, the systems and methods are able to accurately detect people or objects in images that are distorted or feature partial obscurations. The systems and methods achieve this by not requiring predefined features, edges, and/or segmentations to match images. Instead, the systems and methods rely on detected topology patterns. Moreover, the systems and methods may support high resolution content, as well as allow for searching on indexed content without the need to store and/or transmit the indexed content.

The use of a topology pattern in image matching can effectively address the challenges of distortion and partial obfuscation by focusing on the fundamental structural relationships within an image rather than relying on exact visual features. A topology pattern represents the spatial and geometric arrangement of key elements in an image, capturing the relationships between points, lines, or regions that define shapes or configurations in the image. This approach is resilient to distortions because the relative arrangement of these elements remains consistent, even if the image is scaled, rotated, or otherwise altered. Additionally, when objects are partially obscured, the topology pattern still retains enough of its structural integrity to be matched to a database of known patterns. By comparing the extracted pattern with an index of stored patterns, the system can identify potential matches based on structural similarity, even if some parts of the image are missing or distorted. This makes topology-based methods highly robust in scenarios where conventional image processing approaches fail, offering a powerful solution for applications like object recognition, facial analysis, and pattern matching in challenging visual conditions.

Notably, this application has particular relevance to detecting missing persons in video images, especially when such missing persons are minors. As the systems and methods are immune to distortion and partial obfuscation, the systems and methods are particularly effective for detecting people in low grade video images where the person may be in the background, out-of-scene, and/or out-of-focus. Additionally, as only the topology pattern on an image of a person needs to be used, and not the image itself, there is no privacy or security concern related to storing or processing the image (which may be a concern if the image is of a minor). That is, the systems and methods may be run locally on databases of minors without extracting any of the actual images of the minors.

In some aspects, systems and methods for image detection in obscured and/or distorted environments are described. For example, the system may receive a first image. The system may generate a first topology pattern for the first image based on a first location of a first portion in the first image determined to comprise a first image characteristic. The system may compare the first topology pattern to a plurality of index topology patterns. The system may, based on comparing the first topology pattern to the plurality of index topology patterns, determine a confidence that the first image corresponds to an index image. The system may generate for display, on a user interface, a recommendation based on the confidence.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIGS. 1A-1D show illustrative examples of a detection of an image based on a distorted image, in accordance with one or more embodiments.

FIGS. 2A-2C show illustrative diagrams for processing images in order to improve detection, in accordance with one or more embodiments.

FIG. 3 shows illustrative components for an image detection system, in accordance with one or more embodiments.

FIG. 4 shows illustrative components for image detection in obscured and/or distorted environments, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

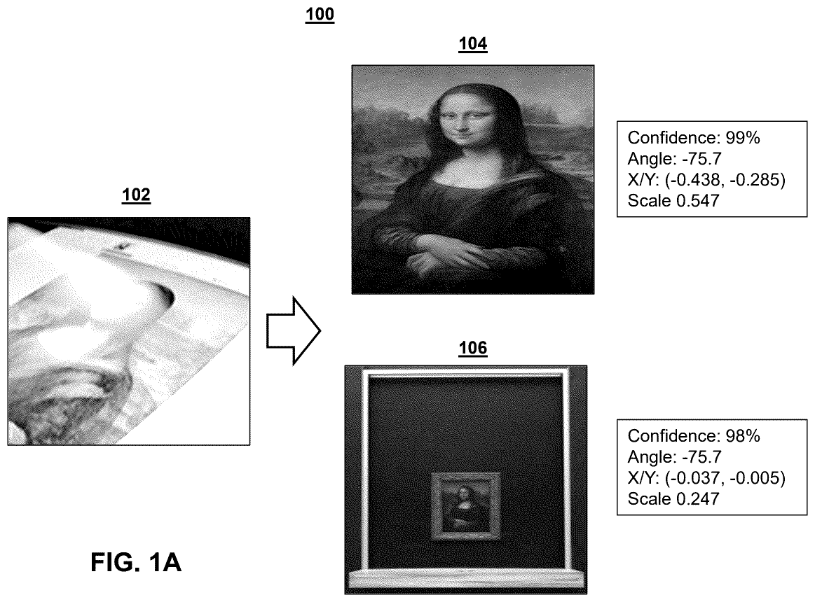

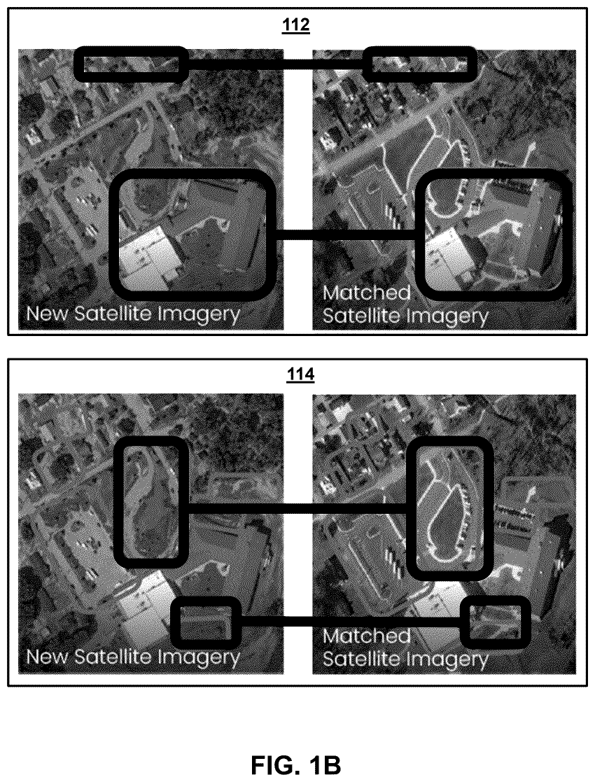

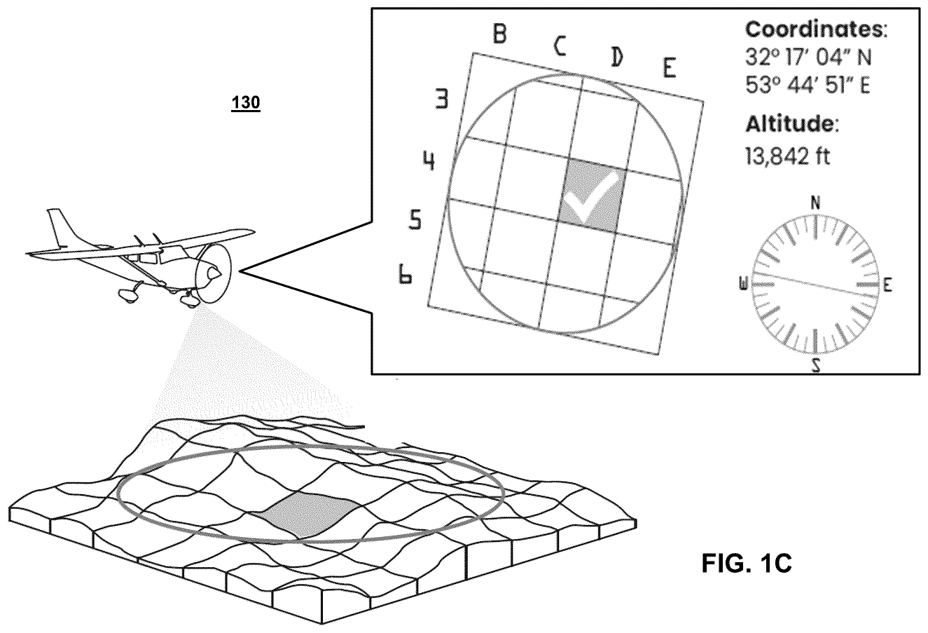

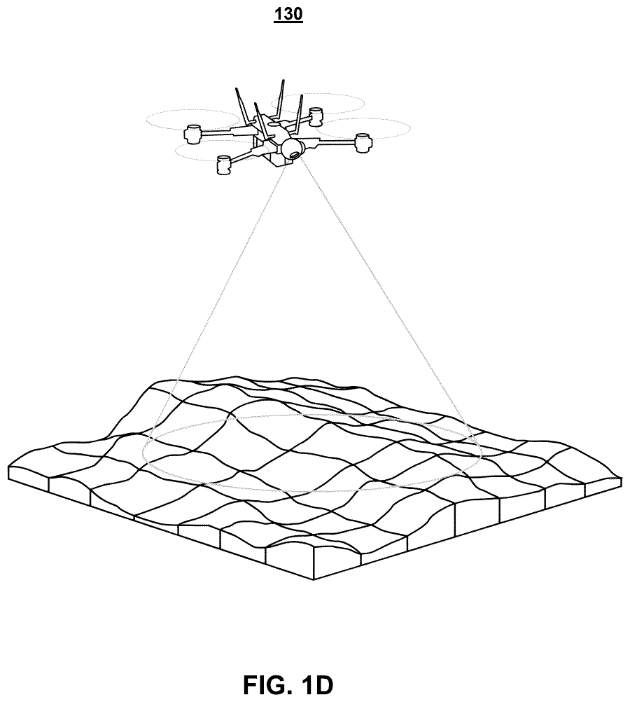

FIG. 1A shows an illustrative example of a detection of an image based on a distorted image, in accordance with one or more embodiments. For example, FIG. 1A shows the detection of an indexed image based on a received distorted image. It should be noted that while embodiments described herein describe the use of detection of images other types of electronically created content may also be used. For example, electronically created content may refer to any digital material that is generated, produced, stored, and/or manipulated using electronic devices and software. This type of content may exist in digital and/or analog formats and may be stored, transmitted, or accessed through computers, mobile devices, and the internet. Electronically created content can include a wide range of media types, such as text, images, audio, video, and/or interactive elements. For example, such content may include digital documents, word processor files, and spreadsheets as well as graphics and digital art, including illustrations, 3D models, and animations, are produced using software. Audio recordings and music, whether in MP3 format or created using digital audio workstations (DAWs), may also fall under this category. In such cases, topology patterns (as described herein may be generate based on samples of audio content (e.g., indicating frequency, wavelengths, and/or other patterns in audio data). Videos, such as user-generated content, video recordings, films edited with software, and/or animated sequences, are another example. Additionally, web content, including blogs, social media posts, and online advertisements, is a form of electronically created content that shapes digital communication. Even code and software applications, developed using programming languages, may, in some embodiments, represent electronically created content, driving automation and digital interactivity.

FIG. 1A shows diagram 100 that includes target content 102 that is being matched to indexed content 104 and indexed content 106. For example, target content 102 may comprise a photograph of another photograph that has resulted in distortions and/or obstruction in the photograph. Indexed content 104 may comprise an image (e.g., retrieved from an index of content) that may be matched to the photograph. In some embodiments, a distortion in content may refer to any alteration, misrepresentation, and/or degradation of the original quality, structure, and/or meaning of a piece of content, often occurring unintentionally due to technical limitations, environmental factors, and/or human intervention. Distortions can appear in various forms across different types of media, impacting the way information is perceived. For example, in visual content, taking a photograph of another photograph may introduce distortions such as blurriness, glare, reflections, and/or misalignment, causing a loss of detail and accuracy compared to the original image. Similarly, in digital media, compressing an image or video file repeatedly can lead to artifacts, pixelation, and color shifts, reducing the clarity of the content. In audio recordings, distortion can occur due to over-amplification, background noise, or encoding issues, leading to unnatural sounds or loss of speech intelligibility. Even in textual content, distortion can take the form of altered meaning due to translation errors, misinterpretations, or poor optical character recognition (OCR) when digitizing printed documents. Such distortions can affect the reliability and authenticity of content, making it crucial to use proper techniques and tools to minimize unintended alterations and preserve the original integrity of the information being conveyed.

FIG. 1A shows diagram 100 that includes target content 102 that is being matched to indexed content 104 and/or index content 106. In some embodiments, the distortion in content may result in and/or be subject to a distortion of an object's representation in the content. For example, distortions in images may arise from various factors that affect the clarity, positioning, and/or overall appearance of objects within the frame. When an object is out of focus, it appears blurry, making it difficult to discern fine details, which can obscure important visual information or alter the intended perception of the image. If an object is out of frame, meaning it is only partially visible or cropped, the viewer loses critical context, potentially misinterpreting the image or missing key details. Similarly, when an object is barely visible due to poor lighting, shadows, or obstructions, it can lead to uncertainty or misidentification. Low resolution or low-grade image quality can also introduce distortions by reducing sharpness and detail, often resulting in pixelation, where objects appear jagged or unclear. Additionally, other visual effects such as glare, motion blur, compression artifacts, and lens distortions can further degrade an object's appearance, making it harder to analyze or interpret the content accurately. These distortions impact not only aesthetic quality but also practical applications such as facial recognition, object detection, and forensic analysis, where precise image details are crucial.

In some embodiments, content may also be subject to one or more obstructions, which may be one type of distortion. For example, an obstruction in content may occur when an element or external factor partially or completely blocks, alters, and/or interferes with the visibility, clarity, or composition of the intended subject in an image, video, or other forms of media. Obstructions may arise from physical objects, environmental conditions, or technical limitations, preventing a clear or accurate representation of the content. For example, when taking a photograph (e.g., target content 102) of another photograph, an obstruction may occur if the camera is tilted, causing distortion, perspective warping, or glare that affects the visibility of details in the original image. Similarly, if another object overlays part of the photograph being captured—such as a hand, a shadow, or a reflection—the obstructed area may be hidden or altered, reducing the completeness of the image. Other obstructions include motion blur, where a moving object passes in front of the subject, or poor framing, where the main subject is unintentionally cut off or blocked. In digital media, obstructions can also occur due to compression artifacts, overlays from watermarks, or pixelation that reduces legibility. These obstructions can compromise the effectiveness, usability, and interpretation of the content, making it essential to minimize or eliminate unwanted elements during content creation, capture, or editing to preserve the accuracy and intent of the original media.

As shown in FIG. 1A, a system may detect indexed content 104 (e.g., an image of the “Mona Lisa”) based on target content (e.g., content 102). Furthermore, the system may generate a recommendation of a match based on the confidence of the match. The system may also determine other characteristics such as a change in angle, a change in scaling, and/or a shift in X/Y coordinates. While this information may be used to determine a confidence of a match, the system may also include these and other characteristics in the recommendation.

For example, a system may generate a recommendation of a match based on the confidence level by analyzing multiple characteristics that influence the accuracy and reliability of the match. The system first processes the input data, comparing key features such as structural patterns, textures, and spatial relationships between the original and potential matching characteristics (e.g., as found in topology patterns). Factors such as changes in angle, scaling variations, and shifts in X/Y coordinates may be used by the system to determine how much transformation has occurred while still maintaining identifiable similarities. Using feature extraction and pattern recognition algorithms, the system quantifies the degree of similarity between two images or objects, assigning a confidence score that reflects the likelihood of a correct match.

In addition to this confidence score, the system may enhance its recommendation by including contextual details about the detected transformations. For example, the system may specify that the match has a 99% confidence level despite a 75-degree rotation, changes in coordinates, and a 0.05% scaling difference, which may help users understand the nature of the match beyond just a numerical value. By integrating confidence scoring with detailed transformation insights, the system provides not only a measure of certainty but also valuable context that helps users interpret and verify the match effectively.

As also shown, the system has identified indexed content 106 as matching. Notably, the system does this despite the content (e.g., the painting of the “Mona Lisa” being background content). That is, the system has detected an object in indexed content 106 that matches the target content. In other embodiments, the system may detect background objects and/or details (e.g., faces, scars, license plate numbers, etc.) in a target image based on indexed content.

Moreover, as the system may only use a characteristic or topology pattern of indexed content (e.g., an image of a person or other personally identifiable information (PII)), the system does not need to store and/or transmit the indexed content itself. As such, the system does not need to store PII and transmit it to another database (e.g., comprising content to be searched). By doing so, the original indexed information is secure and not exposed to any security and/or privacy risks.

For example, the system can mitigate privacy and security risks by ensuring that sensitive content, such as PII or private images, is not stored, transmitted, or exposed during processing. Instead of handling raw content directly, the system can extract and utilize abstracted characteristics or topology patterns derived from indexed content. For example, when indexing an image of a person, the system can generate a feature-based representation—such as a unique hash, biometric template, or mathematical encoding—that captures essential structural details without retaining the original image itself. This transformation allows the system to perform searches, comparisons, or verifications without requiring access to or storage of the actual data. By only working with derived patterns rather than raw content, the system eliminates the need to store, transmit, or share sensitive data, thereby preventing unauthorized access, data breaches, or misuse. Additionally, using homomorphic encryption, differential privacy, or zero-knowledge proofs, the system can process and compare data while maintaining privacy, ensuring that neither the system, nor external entities, gain access to personally identifiable content. In scenarios where data needs to be cross-referenced with external databases, the system can utilize secure multiparty computation (SMPC) techniques, enabling encrypted queries without exposing underlying data. This approach not only enhances security but also ensures compliance with data protection regulations, reinforcing trust in the system's ability to handle sensitive information responsibly. By prioritizing privacy-preserving methods, the system effectively safeguards original indexed information, reducing exposure to security threats while maintaining functionality and efficiency.

FIG. 1B shows diagram 100 and content set 112 and content set 114. Diagram 110 may indicate instances where characteristics are the same (e.g., content set 112) and where characteristics are different (e.g., content set 114). For example, diagram 110 may show an application of the system where a recent satellite image is matched with an older, indexed satellite imagery. The system may use the match data to determine where and how the two images match, allowing the target image's coordinates to be calculated. Additionally, the system may use the match data to describe how the images were distorted and/or obstructed (e.g., how the images where changed). In diagram 110, the system may show instances of change landscaping and/or buildings. In a similar example, the system may be used to detect a deep fake image or other infringing and/or derivative uses of content by comparing a target image to an original and/or indexed image by analyzing inconsistencies, distortions, and unnatural modifications. The system may examine variations in texture, lighting, and color distribution to identify discrepancies that indicate digital tampering, such as detecting deep fake images. The system may then generate a recommendation describing how a target image has been changed and what the original, indexed image showed.

In some embodiments, the system, as depicted in diagram 110, which identifies instances where characteristics are the same (content set 112) and where characteristics are different (content set 114), can be applied across various industries, including medical diagnosis, inventory tracking, missing person investigations, emergency management, drive-thru ordering, and logistic services. In medical diagnosis, the system can compare medical images, such as X-rays or MRIs, to detect anomalies by recognizing characteristics that differ from normal patterns, assisting in early disease detection. In inventory tracking, the system can identify discrepancies between expected and actual stock levels, ensuring that missing, damaged, or misplaced items are flagged in real time. Missing person investigations may benefit from this system by comparing facial features, scars, tattoos, or clothing patterns in surveillance footage against known images to locate individuals efficiently. For emergency management, the system can assess images or sensor data from disaster-stricken areas, identifying structural damages, flooded zones, or hazardous conditions by detecting differences from previously recorded normal conditions. In drive-thru ordering, the system can match a vehicle's license plate or customer profile with stored preferences, ensuring personalized and efficient order processing. Finally, in logistics services, the system helps verify shipments by detecting mismatches in barcode data, package conditions, or routing information, reducing errors and optimizing delivery efficiency.

FIG. 1C shows diagram 130. In diagram 130, an indexed image of a known coordinate may be used to determine a current position of an aircraft (e.g., a drone, airplane, etc.). For example, an indexed image of a known coordinate can be used to determine the current position of an aircraft by leveraging image matching techniques, geographic information systems (GIS), and computer vision algorithms to compare real-time aerial imagery with a pre-indexed reference map. The process begins with the aircraft capturing a live image of the terrain below using onboard cameras or sensors. This image is then analyzed and compared against a database of georeferenced images, where each indexed image is linked to a precise set of GPS coordinates.

Once the system identifies a match, it computes the transformation parameters, such as scale, rotation, and translation shifts, to determine the exact position and orientation of the aircraft relative to the indexed image. By factoring in changes in perspective and altitude, the system refines the positional accuracy using techniques like homography transformation or bundle adjustment. Additionally, integrating sensor fusion from inertial measurement units (IMUs), altimeters, and GPS data further improves accuracy, especially in GPS-denied environments. In military, surveillance, or autonomous navigation applications, this method enables real-time localization, guiding drones or aircraft by continuously updating their position based on terrain recognition. This approach is particularly valuable for terrain-referenced navigation (TRN), where aircraft rely on visual landmarks instead of satellite signals, ensuring reliable positioning even in challenging environments where GPS signals may be weak or unavailable. Moreover, as the aircraft or drone may only comprise only a characteristic or topology pattern of indexed content, the aircraft or drone does not need to store and/or transmit the indexed content. As such, even if the aircraft of drone is captured, the underlying images (e.g., what was being looked for) is secure.

FIG. 1D shows diagram 150. Diagram 150 illustrates a drone that may be used with embodiments described herein. For example, the drone may detect geographic areas such as in diagram 110 (FIG. 1B), may determine positions such as in diagram (FIG. 1C), or may determine other images or objects such as in diagram 100 (FIG. 1A). For example, the drone can use topology patterns to identify different objects and/or images by analyzing the spatial and geometric relationships within an image, allowing it to detect geographic areas, determine GPS positions, and recognize objects in various environments. These topology patterns represent the arrangement of key elements, capturing the relationships between points, lines, and regions that define shapes, terrain features, and structures. For example, when detecting geographic areas, as shown in diagram 110 (FIG. 1B), the drone processes aerial images and extracts topology patterns of landmarks, roads, water bodies, and urban structures. By comparing these patterns to pre-indexed topology maps, the drone can identify known regions, classify terrains, and detect environmental changes. This is particularly useful in agricultural monitoring, disaster response, and urban planning.

Similarly, when determining GPS positions, as illustrated in diagram (FIG. 1C), the drone can use topological relationships between identifiable landmarks to triangulate its position even in environments where GPS signals may be weak or unavailable. By matching its captured topology patterns against pre-mapped reference images, the drone can accurately position itself using feature-based localization techniques. In cases where the drone is tasked with identifying objects or other images, as represented in diagram 100 (FIG. 1A), it can analyze the shapes and structural patterns of detected elements, distinguishing between vehicles, buildings, people, and other objects. The system may leverage edge detection, contour analysis, and machine learning models to recognize patterns that correspond to specific target objects, allowing the drone to track moving entities, assess infrastructure conditions, or perform automated inspections. By integrating topology pattern analysis, the drone enhances its ability to navigate, identify, and categorize elements in complex environments, making it invaluable for applications such as autonomous navigation, reconnaissance, surveillance, mapping, and search-and-rescue operations.

The use of topology patterns also minimizes the risk to sensitive data if a drone is lost by ensuring that captured images are not directly stored or transmitted in their original form. Instead of retaining raw images, the system extracts spatial and geometric relationships within an image, creating a topology pattern that represents the relative positioning of key features without preserving pixel-level details. Because the topology pattern is a mathematical abstraction rather than an exact visual replication, it cannot be reverse-engineered to reconstruct the original image. This means that even if a drone is compromised, intercepted, or lost, the sensitive imagery it processed remains secure and inaccessible. For example, when a drone surveys restricted areas, infrastructure, or classified locations, it converts the visual data into a topology pattern that encodes shapes, relative distances, and object relationships while omitting identifying details such as textures, colors, or personally identifiable information (PII). If an adversary gains access to the drone, they would only retrieve topological data points, which alone lack the resolution or contextual details needed to reveal sensitive information.

Additionally, this approach enhances compliance with data privacy regulations and military security standards, since no raw images containing faces, sensitive installations, or classified environments are stored on the drone. Even if the topology pattern is used for object recognition, mapping, or geolocation, it remains a privacy-preserving representation that allows secure analysis and retrieval without exposing critical visual data. By implementing topology-based data abstraction, drones can operate in high-risk environments while maintaining data integrity, security, and confidentiality, ensuring that sensitive locations, individuals, and infrastructure remain protected even in the event of hardware loss or unauthorized access.

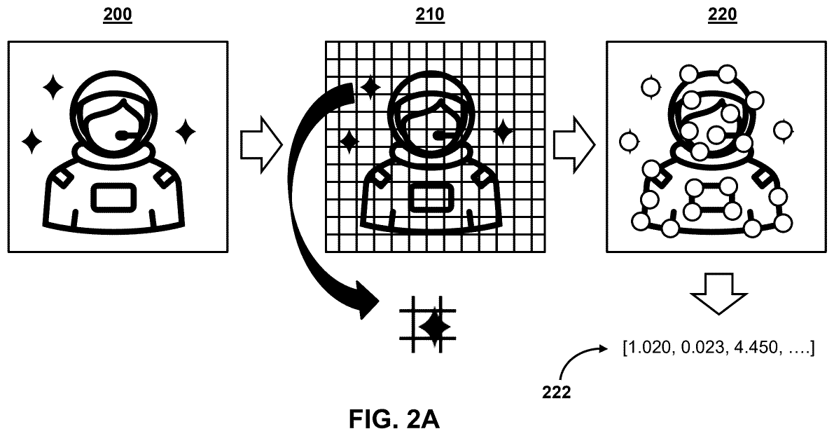

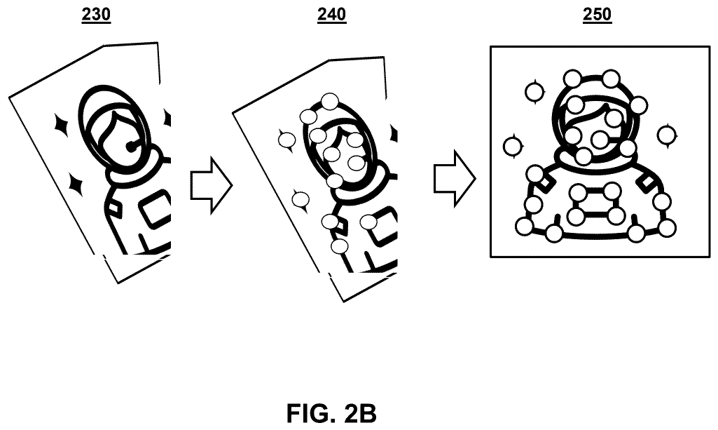

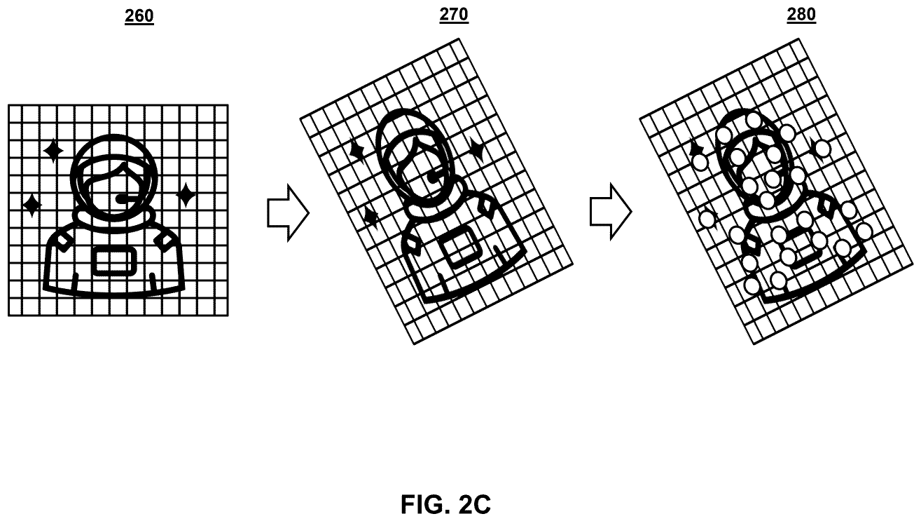

FIGS. 2A-C show illustrative diagrams for processing images in order to improve detection, in accordance with one or more embodiments. For example, FIGS. 2A-C may describe the process of generating a topology pattern for an image based on a location of a portion in the image determined to comprise an image characteristic.

As described herein, a characteristic may be any content that distinguishes one portion from another. For example, with respect to images, an image characteristic refers to a distinguishing feature or attribute within an image that sets a particular portion apart from others, based on its visual properties. These characteristics may define the structure, composition, and/or uniqueness of different regions within an image, making them identifiable and comparable. For example, an image characteristic can be a distinctive shape, texture, color, edge, and/or pattern that contrasts with surrounding areas, allowing it to be recognized as a unique element. A landmark or specific object (or part thereof) within an image, such as a building, tree, or facial feature, may also serve as a characteristic, enabling detection and differentiation from other parts of the content.

Additionally or alternatively, characteristics may include patterns, geometric structures, or pixel intensity variations. These patterns, geometric structures, or pixel intensity variations may represent objects and/or features in the content. For example, in facial recognition, for instance, image characteristics such as eye distance, nose shape, and/or jawline structure may differentiate individuals. Similarly, in medical imaging, a characteristic based on a tumor's shape, density, or contrast level compared to surrounding tissues can be an image characteristic used for diagnosis.

FIG. 2A shows an illustrative diagram for identifying a plurality of portions in the index image based on one or more respective image characteristics in the plurality of portions, in accordance with one or more embodiments. For example, FIG. 2A shows original image 200. As shown in FIG. 2A original image 200 in divided into plurality of portions 210. The location of these portions and/or information about the characteristics therein may then be used to generate a topology pattern 220 based on respective locations of portion in plurality of portions 210 that include a characteristic.

A system processes an original image (e.g., original image 200) by dividing it into a plurality of portions, extracting key characteristics from each portion, and using this information to create a topology pattern that describes the structure of the image. The division of the image can be performed using grid-based segmentation, region-based analysis, and/or feature-detection algorithms, ensuring that each portion captures meaningful visual details. The system then analyzes each portion individually, identifying distinct characteristics such as edges, textures, shapes, color variations, or contrast differences that help distinguish one portion from another.

Once these characteristics are extracted, the system maps the portions to their respective locations within the image, creating a structured representation of how different segments relate to each other. This spatial organization is crucial in generating a topology pattern, which captures the overall layout and relationships between image portions without relying on pixel-by-pixel comparisons. The topology pattern can serve as a compressed and privacy-preserving representation of the image, useful for applications such as image matching, recognition, and classification. For example, in an index image database, the system can store topology patterns instead of full images, enabling fast searches by comparing the structural relationships of an incoming query image with indexed topology patterns. This approach enhances efficiency and security while allowing accurate recognition, making it valuable for biometric identification, geographic mapping, object detection, and automated surveillance.

For example, the system may determine a topology pattern by analyzing the locations of portions within an image that contain identified characteristics, then encoding these locations using reference points relative to the overall image (or content) dimensions. The process begins by segmenting the image and detecting key features (e.g., characteristics) through techniques such as edge detection, contour analysis, or deep learning-based feature extraction. Once significant portions of the image are identified, the system maps their spatial relationships with respect to each other, ensuring that each portion's position is represented relative to a fixed coordinate system.

To standardize these locations, the system enumerates reference points based on normalized image dimensions. For example, if an image is 500×500 portions, an identified characteristic at portion (250, 375) may be normalized as (0.5, 0.75) to allow for consistent comparison across images of different resolutions (e.g., clusters or groups of portions) and different images (e.g., images that may comprise the target image). This approach ensures that the topology pattern remains scalable and independent of absolute image size, enabling accurate matching even if images vary in resolution or aspect ratio.

The system then constructs the topology pattern as a mathematical representation, encoding relative distances, angles, and spatial relationships between the locations. This representation may be stored as a vector array, adjacency matrix, or graph structure, allowing for efficient pattern matching and retrieval. By using locations linked to overall image dimensions (or portions in the image), the system ensures that topology patterns are consistent, scalable, and robust against variations in image size, orientation, or partial obstructions.

As described herein, a topology pattern may be a structured representation that describes the spatial relationships, organization, and/or positioning of key portions within content. For example, rather than the direct characteristics of the content itself, the topology pattern serves as a map that outlines the relative locations, distances, numbers, and/or connections between identified portions of an image, text, or dataset, allowing for robust pattern recognition and comparison. For example, in an image, a topology pattern may define the placement of facial features (eyes, nose, mouth) relative to each other without storing specific color or texture details, making it resilient to distortions such as brightness changes or minor occlusions.

For example, because a topology pattern captures the structural layout instead of relying on exact pixel data, it allows a system to match content even if it is altered, distorted, or partially obstructed. For instance, if an object is rotated, resized, or partially hidden, its defining relationships—such as proportional distances between detected features—can still be recognized. This makes topology patterns valuable in applications like facial recognition, fingerprint analysis, medical imaging, and object detection, where exact matches may not always be available, but underlying spatial relationships remain consistent. Furthermore, topology patterns can be applied in geographic mapping, where landmarks' relative positions are analyzed rather than their visual details, allowing systems to compare maps even if some elements are missing or altered. By focusing on positional relationships instead of raw characteristics, a topology pattern provides a privacy-preserving, efficient, and flexible approach to content analysis and recognition across various domains.

As shown in FIG. 2A, topology pattern 220 may be described in a numerical array, such as vector array 222, by encoding the spatial relationships, distances, and structural organization of key portions of the content into a structured mathematical format. Instead of storing raw pixel data or detailed characteristics of an image or object, the system identifies distinct reference points, key features, or segments, then assigns numerical values to represent their relative positions, distances, angles, and connectivity. These values are then arranged into a vector array, where each element corresponds to a specific spatial property, such as X/Y coordinates, relative distances, or geometric transformations.

For example, in an image recognition system, a face topology pattern might be represented as a vector array where each facial feature (eyes, nose, mouth, etc.) is mapped based on normalized distances and angles between them. A sample vector representation could be [X1, Y1, X2, Y2, d1, d2, θ1, θ2], where (X, Y) values represent feature coordinates, d values represent Euclidean distances between features, and θ values represent angular relationships. Similarly, in an object detection system, a topology pattern may be expressed as a set of bounding box coordinates and keypoint relationships, forming an array that defines an object's structure regardless of rotation, scale, or distortion.

By using a vector-based numerical representation, the system enables efficient comparison, pattern matching, and classification, even when the original content is altered, obstructed, or transformed. This numerical encoding makes topology patterns highly useful in machine learning, biometric recognition, medical imaging, geographic mapping, and surveillance, allowing the system to identify structural similarities without relying on exact pixel matches. Additionally, vector-based representations facilitate fast searching and indexing, as mathematical comparisons are more computationally efficient than raw image processing, making topology-based recognition scalable across large datasets.

Storing the topology pattern as a numerical array preserves the privacy and security of the original content by ensuring that the system does not retain or transmit raw data that could expose sensitive information. Instead of storing the actual image, document, or content, the system abstracts its structural relationships into a vector-based representation, which only contains mathematical descriptions of spatial arrangements, distances, and feature relationships. This means that even if the stored topology pattern is accessed by unauthorized parties, it cannot be reverse-engineered to reconstruct the original content with full fidelity.

For example, in facial recognition, rather than storing an actual image of a person, the system extracts a topology pattern describing the relative positions of key facial landmarks (e.g., eyes, nose, and mouth) and encodes them into a numerical array. Because this representation lacks raw pixel data, color, or texture information, it does not expose identifiable details that could be exploited. Similarly, in medical imaging, a system can store the structural relationships of anomalies or organ features instead of actual patient scans, ensuring that sensitive health information remains secure while still allowing for diagnostic comparisons.

Additionally, numerical topology patterns support encryption, hashing, and differential privacy techniques, further enhancing security. Since topology-based data consists of numerical values rather than identifiable content, it can be securely transmitted, stored, or compared without violating privacy regulations. This abstraction ensures that the system can perform authentication, anomaly detection, and pattern recognition without exposing private data, making it a privacy-preserving solution for biometrics, surveillance, cybersecurity, and secure data analysis.

FIG. 2B shows an illustrative diagram for comparing the target topology pattern to the plurality of index topology patterns, in accordance with one or more embodiments. For example, the system receives target image 230 and generates target topology pattern 240 for target image 230. For example, the system receives target image 230 and generates target topology pattern 240 by processing the image through a series of steps that extract key structural relationships while discarding unnecessary raw data. For example, the system may segment target image 230 into distinct regions, identifying important features such as edges, shapes, contours, or landmarks therein. Once these key portions of the image are identified, the system calculates spatial relationships between their locations, which may include relative positions (X/Y coordinates), distances, angles, and geometric transformations (scaling, rotation, perspective shifts).

For example, the system may calculate spatial relationships between the locations of portions in an image by analyzing their relative positions, distances, angles, and geometric transformations using mathematical and computational techniques. First, the system identifies key portions within the image using feature detection algorithms such as SIFT (Scale-Invariant Feature Transform), ORB (Oriented FAST and Rotated BRIEF), or SURF (Speeded-Up Robust Features). These algorithms detect distinctive points of interest, such as edges, corners, or unique textures, and assign X/Y coordinates to define their positions within the image.

Once the key portions are identified, the system calculates distances between them using Euclidean distance formulas, which determine how far one point is from another based on their coordinate positions. Additionally, angular relationships between portions are computed using trigonometric functions, such as the arctangent (atan2) function, to measure orientation angles between key points relative to a reference axis.

To account for geometric transformations, the system analyzes scaling, rotation, and perspective shifts by applying homography transformations and affine transformations, which map corresponding points between different images while adjusting for distortions. Scaling is determined by comparing the ratio of distances between features in different instances of the image, while rotation is measured by comparing the angular displacement of key points. Perspective shifts are calculated using matrix transformations and homography estimation, ensuring that objects remain recognizable even when viewed from different angles.

By encoding these spatial relationships into a numerical array (vector representation), the system generates a topology pattern that allows for robust image comparison, recognition, and matching across different conditions. This method is essential in applications such as biometric recognition, object detection, medical imaging, and geographic mapping, where identifying patterns despite variations in scale, orientation, or perspective is critical for accurate analysis.

The extracted structural data may then be formatted into target topology pattern 240, which may be represented as a numerical array or vector that encodes the spatial relationships rather than the actual pixel data of the original image. This transformation allows the system to compare the target image against an indexed dataset while maintaining privacy and computational efficiency. Because topology patterns focus on structural arrangements rather than absolute visual details, they enable robust matching even when the target image has distortions, partial occlusions, or variations in lighting and resolution.

The system then compares target topology pattern 240 to a plurality of index topology patterns to identify a matching topology pattern (e.g., topology pattern 250). For example, the system may compare target topology pattern 240 to a plurality of indexed topology patterns to identify a matching topology pattern (e.g., topology pattern 250) by analyzing structural relationships and performing similarity measurements. First, the system extracts the numerical representation of the target topology pattern, which encodes the spatial relationships of key portions, including relative positions (X/Y coordinates), distances, angles, and geometric transformations (scaling, rotation, and perspective shifts). This representation is then compared against a database of indexed topology patterns, each representing pre-processed reference images or content.

The system uses pattern-matching algorithms and similarity metrics to evaluate how closely the target topology pattern aligns with each indexed topology pattern. One approach is Euclidean distance or cosine similarity, which measures how similar the vectorized representations of the topology patterns are. If the topology pattern includes keypoint-based relationships, feature-matching algorithms such as FLANN (Fast Library for Approximate Nearest Neighbors) or BFMatcher (Brute Force Matcher) may be used to determine correspondences between the target and indexed topology patterns. In some embodiments, machine learning models, particularly convolutional neural networks (CNNs) or graph-based neural networks (GNNs), can be employed to learn and identify matching structural patterns even if the target image has distortions, partial occlusions, or variations in perspective.

Once the system identifies a match with a confidence score above a predefined threshold, the system may determine topology pattern 250 as the most likely corresponding match to the target topology pattern 240. This process enables the system to recognize and verify content efficiently, making it useful for applications such as biometric authentication, image retrieval, forensic analysis, medical diagnosis, and object recognition, where structural consistency is crucial despite potential variations in appearance.

FIG. 2C shows an illustrative diagram for normalizing a topology pattern, in accordance with one or more embodiments. For example, in some embodiments, the system may receive plurality of portions 260 (which in some embodiments may correspond to plurality of portions 210 (FIG. 2C)) and may normalize the underlying topology pattern by scaling, rotating, and/or skewing the image. Nonetheless, the topology pattern is preserved as the relationships between the locations identified by the topology pattern are preserved. The system may then store the normalized topology pattern for comparison to target topology patterns.

For example, the system normalizes a topology pattern by applying transformations, such as scaling, rotation, and skewing to align and standardize the representation of spatial relationships within an image while preserving its underlying structural relationships. Upon receiving a plurality of portions 260, which may correspond to plurality of portions 210 (FIG. 2C), the system first analyzes the relative positions, distances, and orientations of the identified portions. Because images may vary in size, angle, and perspective due to different capture conditions, the system performs normalization to ensure that topology patterns remain consistent and comparable across different instances.

To achieve normalization, the system may apply affine transformations and homography adjustments that scale, rotate, and skew the image while maintaining the proportional relationships between the locations of key portions. Scaling normalization ensures that images of different resolutions or zoom levels have the same reference dimensions, allowing direct comparison between topology patterns. Rotation normalization corrects for variations in image orientation by aligning key features to a standard frame of reference, such as centering a face in biometric recognition or aligning a landscape in geographic mapping. Skew correction (perspective normalization) adjusts for distortions caused by different camera angles, ensuring that features retain their true geometric relationships. Based on the normalization, the system may generate normalized plurality of portions 270.

Normalized plurality of portions 270 may then be used to determine normalized locations of different image characteristics. The system may then generate a topology pattern (e.g., topology pattern 280) based on normalized plurality of portions 270. Once the topology pattern is normalized, it is stored in a structured format, such as a vectorized numerical representation, allowing the system to efficiently compare it against target topology patterns without being affected by inconsistencies in image capture. This method enhances the robustness of pattern recognition, object detection, and authentication systems, ensuring that matches can be identified even when images are distorted, rotated, or resized. Normalization is critical in applications, such as biometric verification, medical imaging, satellite mapping, and forensic analysis, where consistent structural relationships must be maintained across diverse datasets for accurate comparison and identification.

Additionally or alternatively, the system may incrementally update indexed images and/or topology patterns thereof. For example, the system may update indexed images as new objects or details are detected by dynamically modifying and expanding topology patterns to reflect changes in an image while maintaining its core identity and structure. When an image is initially indexed, the system generates a topology pattern that captures the spatial relationships, shapes, textures, and other distinguishing characteristics of detected objects, such as people, vehicles, or cargo. As new data is collected—whether through new images, real-time camera feeds, or additional metadata—the system continuously analyzes changes and updates the indexed images and topology patterns accordingly.

For example, if a person is identified and indexed in a database, their topology pattern is originally based on distinct facial features, body proportions, and contextual elements. However, as the person changes outfits, hairstyles, or vehicles, the system detects these variations and incrementally updates the indexed topology pattern. The system ensures that while new variations are stored, the original identity remains linked, enabling robust identification even when external appearances change. This allows for accurate person detection regardless of different clothing, accessories, or temporary modifications to their appearance.

Similarly, when tracking a vehicle, such as a truck, the system initially indexes the topology pattern based on unique shapes, colors, decals, and structural features. If the truck adds cargo, such as a trailer or shipments, the system updates the indexed pattern by integrating new cargo attributes while preserving the original base structure of the truck. This enables the system to search for the truck based on either the truck itself or its newly added cargo, improving flexibility in tracking, logistics, and security monitoring.

By implementing continuous learning and adaptive updates, the system ensures that indexed images remain accurate, relevant, and capable of recognizing objects despite real-world changes. This method is particularly useful for biometric authentication, law enforcement surveillance, vehicle tracking, supply chain monitoring, and automated security systems, where the ability to track evolving objects or individuals over time is essential.

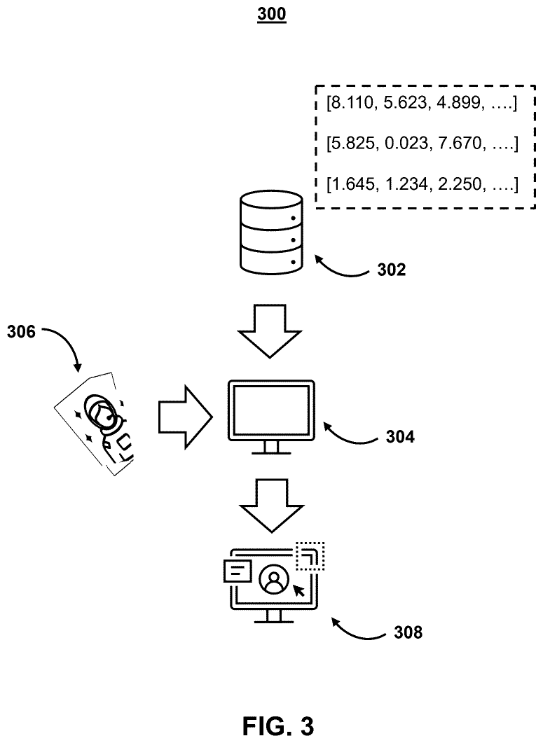

FIG. 3 shows illustrative components for a system used for image detection in obscured and/or distorted environments, in accordance with one or more embodiments. For example, system 300 shows database 302, which may comprise an index of content. Database 302 may store content such as indexed images, topology patterns for images, and other structured data using various storage architectures, including relational databases or NoSQL databases, depending on system requirements. Database 302 may store content (e.g., indexed images, topology patterns for images, etc.).

In some embodiments, database 302 may use a flat file architecture. In a flat file architecture, content is stored in simple text files, CSV files, JSON, or XML formats, where each record contains structured information, such as an image identifier, associated topology pattern, and metadata. This approach is lightweight and efficient for small-scale applications where complex querying is not required, but it can become inefficient for large datasets due to slow lookup times and lack of indexing capabilities.

For more complex and scalable applications, relational databases (SQL-based, such as MySQL, PostgreSQL, or SQLite) may be used, where indexed images and topology patterns are stored in tables with unique identifiers and relational mappings. This enables efficient structured queries, indexing, and cross-referencing between images and their corresponding topology patterns. Alternatively, for high-performance and large-scale systems, NoSQL databases provide document-based or graph-based storage, allowing fast retrieval, flexible data models, and distributed storage capabilities.

Regardless of the storage method, database 302 typically organizes indexed content by associating each piece of content with a precomputed topology pattern, which may be stored as a numerical vector, adjacency matrix, or feature descriptor set. This enables the system to quickly compare target topology patterns against indexed patterns without retrieving full image files, improving efficiency, security, and privacy. Additionally, metadata indexing (such as timestamps, image sources, and classification labels) further enhances search capabilities, enabling use cases in biometric authentication, medical imaging, forensic analysis, logistics tracking, and AI-driven pattern recognition.

As shown in FIG. 3, system 300 may include device 304. Device 304 (as well as the other devices and components described herein) may comprise electronic storage. Electronic storage devices are systems designed to electronically store information in various formats and media. These devices may utilize non-transitory storage and/or computer-readable media to retain data and can include both system storage, which is integrally provided within servers or client devices (e.g., substantially non-removable storage), and removable storage that can be connected to servers or client devices through interfaces such as USB ports, FireWire ports, or disk drives. Electronic storage media encompass a wide range of technologies, including optically readable storage media like optical disks, magnetically readable storage media such as magnetic tapes, hard drives, and floppy disks, as well as electrical charge-based storage media like EEPROM and RAM. Solid-state storage media, such as flash drives, are another common type of electronic storage. Additionally, virtual storage resources, including cloud storage, virtual private networks (VPNs), and other virtualized systems, are considered part of electronic storage. These devices are capable of storing various forms of data, including software algorithms, information processed or determined by processors, data obtained from servers or client devices, and other essential information that supports the functionality of various processes.

Device 304 may receive content (e.g., content 306) for matching with indexed content (e.g., indexed images, indexed topology patterns, etc.) to generate a recommendation (e.g., recommendation 308). Device 304 receives content (e.g., content 306) for matching with indexed content (e.g., indexed images, indexed topology patterns, etc.) by processing incoming data and extracting relevant structural features to generate a comparison-based recommendation (e.g., recommendation 308). The process may begin when device 304 captures or receives an image, document, or dataset through various input methods such as cameras, sensors, file uploads, or API requests. Once the content is acquired, the system preprocesses it by performing segmentation, feature extraction, and topology pattern generation, converting the raw content into a numerical representation that describes its spatial structure and relationships.

Once the target topology pattern is created, device 304 transmits it to a matching engine, which searches database 302 for similar or identical topology patterns stored in indexed records. The system uses pattern-matching algorithms, distance metrics (e.g., Euclidean, cosine similarity), and machine learning models to compare the target topology pattern against pre-existing indexed patterns efficiently. The comparison process accounts for scaling, rotation, distortion, and partial obstructions, ensuring robust recognition across varying conditions. If a match is found, the system assigns a confidence score to quantify the likelihood of a correct match and then generates a recommendation (e.g., recommendation 308) based on the best-matching indexed content.

In some embodiments, system 300 and/or one or more components herein may be implemented using an application-specific integrated circuit. An integrated circuit may be a small electronic device made of semiconductor material, typically silicon, that contains a large number of microscopic electronic components, such as transistors, resistors, capacitors, and diodes. These components are interconnected to perform a specific function or set of functions. Integrated circuits can be classified into various types based on their functionality, such as analog, digital, and mixed-signal ICs. The transistors within an IC are the primary building blocks, as they act as switches or amplifiers for electronic signals. The other components, like resistors and capacitors, are used for controlling voltage, current, and timing within the circuit. System 300 may design the integrated circuit to be application specific such that the design of the circuit is customized for a given application. In some embodiments, system 300 may use an integrated circuit system, where one or more integrated circuits are spread throughout a system, network, and/or one or more devices. In such a case, the system design may ensure that the circuits are integrated with other electronic components like connectors, power supplies, and sensors to form a complete and functional electronic system. This integration allows for the implementation of sophisticated tasks in devices needed for one or more specified applications.

System 300 may send and/or receive data to device 304. Device 304 may function as a storage device, such as a CPU. A CPU, or Central Processing Unit, is the primary component of a computer responsible for executing instructions and performing computations necessary for various processes and functions. The CPU may interpret and execute instructions from programs and operating systems through a cycle of fetching, decoding, and executing commands. This cycle begins with the CPU retrieving an instruction from the system's memory, followed by decoding it to understand the required operation, and finally, executing it by performing arithmetic, logical, control, or input/output tasks. The CPU relies on its internal components, including the arithmetic logic unit (ALU) for mathematical operations, the control unit (CU) for directing data flow, and registers for temporary data storage. By leveraging its clock speed and multiple cores in modern processors, the CPU can execute complex processes efficiently, enabling the functionality of applications and systems.

Device 304 processes the received data by implementing one or more applications and/or models to perform specific tasks or computations. These applications or models analyze, transform, or process the input data to produce the desired output. This output may represent the results of calculations, simulations, or other operations conducted by the applications or models on device 304. The system ensures seamless communication between the devices, allowing for efficient data transfer and output generation.

In some embodiments, system 300 may protect code that processes received data by implementing security features designed to prevent reverse engineering, ensuring that sensitive applications, models, and computations remain protected from unauthorized access or modification. One common approach is to use a supplemental program that hashes, encrypts, or obfuscates the underlying code to make it difficult for attackers to analyze or decompile. Code obfuscation transforms the original code into an unreadable format while preserving functionality, making it significantly harder for an adversary to reverse-engineer the logic. Techniques such as control flow obfuscation, string encryption, and dead code insertion are used to deter static and dynamic analysis.

In addition to obfuscation, the system may use encryption mechanisms where the executable code or machine learning models are stored in an encrypted format and only decrypted in trusted execution environments (TEEs) or at runtime using secure keys. Code signing and integrity checks can further enhance security by verifying that the code has not been tampered with before execution. Hardware-based protections, such as Trusted Platform Modules (TPMs) or Secure Enclaves, can restrict access to cryptographic keys, ensuring that even if an attacker gains access to the system, they cannot decrypt or modify the secured application.

To further prevent reverse engineering, the system may implement anti-debugging and anti-tampering techniques, such as detecting debugging tools, memory analysis attempts, or virtual machine environments, and responding by terminating execution or introducing deceptive logic to mislead attackers. In cases where machine learning models are involved, homomorphic encryption or secure multiparty computation (SMPC) can allow computations to be performed on encrypted data without revealing the underlying model or logic.

In some embodiments, the system may use a one-way function to describe a topology pattern by transforming underlying images or content into a mathematical representation that captures only structural relationships while making it computationally infeasible to reconstruct the original image or data. This ensures that sensitive content, such as personally identifiable information (PII) or obscene material, does not need to be stored, transmitted, or shared. The one-way function applies hashing, cryptographic transformations, or feature encoding to convert the spatial relationships, geometric structures, and key feature distributions of an image into a fixed-length representation that uniquely characterizes the topology pattern.

This one-way transformation is particularly beneficial in environments where privacy and content security are paramount, such as medical imaging, law enforcement, biometric authentication, or content moderation systems. Because the system does not store or share raw images, it ensures compliance with privacy regulations, reducing the risk of data breaches, unauthorized access, or exposure of sensitive content. Additionally, in cases where the original image contains obscene or restricted material, the system prevents the dissemination of inappropriate content while still enabling analytical functions such as pattern matching, classification, and anomaly detection.

The one-way function also allows topology patterns to be searched within datasets containing PII without directly exposing or accessing the original data. Because the topology pattern is a mathematical abstraction rather than a raw image, encrypted or anonymized datasets can be queried for matches without requiring direct access to personal data. For example, in a biometric identification system, a hashed topology pattern of a fingerprint or facial scan can be searched against a securely stored index without revealing the actual biometric data. Similarly, in content moderation, topology patterns of illegal or harmful content can be compared against an indexed database without handling or distributing the explicit material.

In some embodiments, system 300 may use an I/O (Input/Output) path between devices, which may refer to the communication pathway that facilitates the exchange of data between computing devices or systems. An I/O path may encompass a variety of communication networks such as the Internet, mobile phone networks, mobile voice or data networks like 5G or LTE, cable networks, public switched telephone networks (PSTN), or combinations of these. These networks provide the infrastructure for transmitting data across different mediums. The I/O path can also include specific communication paths, such as satellite links, fiber-optic connections, cable connections, Internet-based communication paths (e.g., IPTV), and free-space links that support wireless or broadcast signals. In addition to external communication networks, computing devices may feature internal communication paths that integrate hardware, software, and firmware components. For example, multiple computing devices can operate as part of a unified cloud-based platform, leveraging interconnected communication paths to function collectively. These I/O paths are essential for ensuring seamless data flow, supporting applications, and enabling distributed computing environments.

In some embodiments, system 300 may be a cloud system. A system structured as a cloud system is designed to provide scalable, on-demand access to computing resources and services over the Internet or other networks. In a cloud system, multiple interconnected servers, data centers, and storage devices work together to deliver virtualized computing power, storage, and applications. These resources are hosted remotely in distributed locations, creating a virtualized environment that can dynamically allocate resources based on user demands. The cloud system is typically organized into three main service models: Infrastructure as a Service (IaaS), which offers virtualized hardware and network resources; Platform as a Service (PaaS), which provides tools and frameworks for application development; and Software as a Service (SaaS), which delivers software applications to users. The system relies on communication paths, including high-speed fiber-optic networks, satellite links, and wireless connections, to enable seamless interaction between users and the cloud infrastructure. Advanced management tools and load-balancing mechanisms ensure reliability, efficiency, and fault tolerance within the system. This structure allows users to access computing resources flexibly and cost-effectively without the need to maintain physical hardware.

In some embodiments, system 300 may use one or more APIs. An API, or Application Programming Interface, is a set of rules and protocols that allows different components within a system, such as system 300, to communicate and interact seamlessly. APIs define how software applications, services, or devices can request and exchange data, enabling interoperability between components regardless of their underlying technologies. Within a system, an API acts as a bridge between different modules, such as databases, user interfaces, or external services, facilitating the flow of information and the execution of commands.

System 300 may generate a recommendation (e.g., recommendation 308) on a user interface. The recommendation may include contextual details, such as matched image references, metadata (e.g., timestamps, classification labels), or similarity analysis results, depending on the application. This enables a wide range of use cases, including facial recognition, medical diagnostics, inventory tracking, security authentication, and forensic investigations. By leveraging efficient topology-based comparisons rather than raw data storage, device 304 ensures privacy, security, and computational efficiency, allowing for real-time or near-real-time content matching while minimizing exposure to sensitive information.

A user interface (UI) may be the point of interaction between a user and a system, software, or device, allowing users to input commands, receive feedback, and navigate functionalities in an intuitive and efficient manner. It serves as a bridge between humans and technology, enabling users to interact with digital or physical systems through visual, auditory, or tactile elements. A well-designed UI incorporates graphical components such as buttons, menus, icons, text fields, dashboards, and images, making it easier for users to understand and operate the system. In addition to graphical user interfaces (GUIs) found in websites, mobile apps, and software, other types of UIs include voice user interfaces (VUIs), used in virtual assistants, and gesture-based interfaces, which rely on motion detection for interaction.

Once a match is identified, the system formats the recommendation output into an interpretable format for the user interface. The UI may display a list of possible matches, ranked by confidence score, along with supporting details, such as matched images, similarity percentages, metadata, timestamps, classification labels, or verification status. For visual applications, such as biometric identification or object recognition, the UI may highlight the matched portions of the image with bounding boxes, heatmaps, or overlay markers, helping users understand the basis of the recommendation. For logistics or inventory tracking, the UI might present scannable barcodes, location data, or shipping status updates.

Additionally, the user interface may allow for user interaction, enabling feedback mechanisms such as manual verification, corrections, or refinements to the recommendation. The system can also integrate real-time alerts or notifications, ensuring that users receive immediate insights, especially in time-sensitive applications like security screening, medical diagnostics, emergency response, and fraud detection. By presenting recommendation 308 in an intuitive and accessible manner, system 300 enhances decision-making, accuracy, and operational efficiency across various applications.

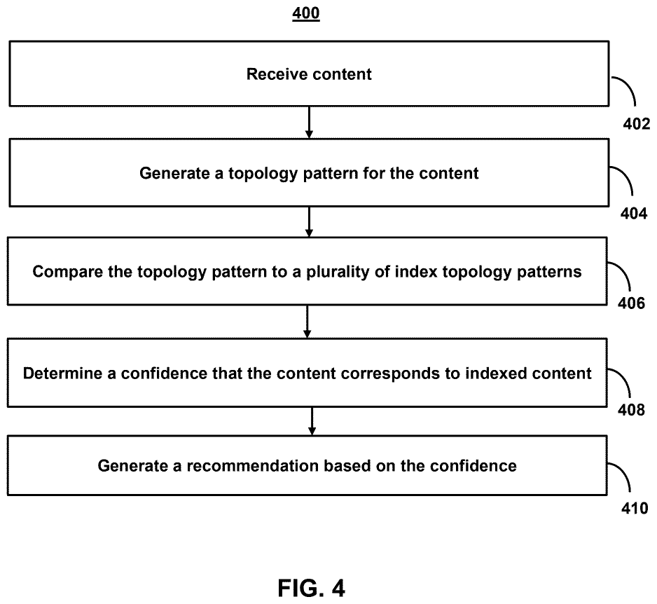

FIG. 4 shows illustrative components for image detection in obscured and/or distorted environments, in accordance with one or more embodiments. For example, the system may use process 400 (e.g., as implemented on one or more system components described above) for that includes initial analysis and tagging routines prior to dynamically selected extraction routines.

At step 402, process 400 (e.g., using one or more components described above) receives content. For example, the system may receive a first image. For example, the system may receive an image through direct capture from a camera or sensor, where an image is taken in real-time from a connected device, such as a smartphone, security camera, medical imaging device (MRI, X-ray), or drone. The system may also receive an image via file uploads, where users manually select and submit an image from their local storage or cloud-based platforms. In other cases, images can be acquired through automated data pipelines, such as surveillance systems, biometric scanners, or inventory tracking solutions, which continuously collect and process images without user intervention. Once the system receives the image, it may undergo preprocessing, such as format conversion, compression, noise reduction, and resolution adjustment, to ensure compatibility and optimize performance for further analysis. The image is then stored temporarily or permanently in a database, cloud server, or memory buffer, depending on whether it needs to be compared, analyzed, or transmitted. Additionally, images can be received via network-based sources, such as APIs, live streams, or remote repositories, where they are fetched dynamically from online services, social media platforms, or third-party systems.

At step 404, process 400 (e.g., using one or more components described above) generates a topology pattern for the content. For example, the system may generate a first topology pattern for the first image based on a first location of a first portion in the first image determined to comprise a first image characteristic. The system may generate a first topology pattern for a first image by identifying key portions of the image that contain distinguishing image characteristics and mapping their spatial relationships. The process begins with the system analyzing the first image to detect and segment meaningful features, such as edges, textures, shapes, or landmarks. Using feature detection algorithms like SIFT (Scale-Invariant Feature Transform), ORB (Oriented FAST and Rotated BRIEF), or deep learning-based models, the system identifies a first portion within the image that contains a notable image characteristic (e.g., a unique shape, facial feature, object contour, or texture anomaly). Once the first location of this portion is determined, the system assigns X/Y coordinates to represent its position relative to the entire image. The system then expands this process by identifying additional portions within the image that contain relevant features, mapping their locations, and establishing relationships between them, such as distances, angles, scaling factors, and geometric transformations. These relationships form the basis of the first topology pattern, which is encoded as a numerical array or vector representation that captures the structural layout of the first image while omitting unnecessary pixel data. By representing the image through its topological relationships, rather than raw visual content, the first topology pattern becomes a privacy-preserving and computationally efficient format for further comparisons.

In some embodiments, the system may generate the first topology pattern for the first image by generating a greyscale version of the first image and determining the first portion has the first image characteristic based on the greyscale version. For example, the system may generate a first topology pattern for the first image by first converting the image into a greyscale version, which simplifies the analysis by removing color information while preserving essential structural details such as edges, textures, and contrasts. This transformation reduces computational complexity and enhances the system's ability to detect image characteristics that define the topology pattern. For example, the system determines that a first portion within the image contains a first image characteristic, which may be a distinguishing shape, contour, texture, or contrast difference relative to the rest of the image in greyscale. For example, in facial recognition, the system may detect facial landmarks such as the eyes, nose, or mouth based on intensity changes in the greyscale version.

In some embodiments, the system may generate the first topology pattern for the first image by determining a second location of a second portion in the first image determined to comprise a second image characteristic and determining a relationship between the first location and the second location. For example, the system may generate the first topology pattern for the first image by identifying multiple distinct portions within the image that contain key image characteristics and then mapping the spatial relationships between them. Once a first portion is identified, the system assigns it a first location (X/Y coordinate) and marks it as a reference point within the image. Next, the system continues scanning the image to detect a second portion containing a second image characteristic, which may be another key feature relevant to object recognition, facial structure, or geometric topology. This second portion is assigned a second location (X/Y coordinate), allowing the system to establish a spatial relationship between the first and second portions. The relationship is defined by calculating distances, angles, orientation, and other geometric transformations between these key points. The system may use Euclidean distance formulas to measure the separation between points, angular measurements (trigonometric functions like arctan) to determine orientation, and homography transformations to account for perspective shifts. As the system continues detecting additional portions and their relationships, it constructs a topology pattern that encodes the structural arrangement of the image rather than raw pixel data. This vector-based representation ensures that the pattern is scalable, distortion-resistant, and privacy-preserving, allowing the system to compare images efficiently, even when they are rotated, resized, partially obscured, or distorted. Once the first topology pattern is finalized, it is stored for future matching, classification, or anomaly detection in applications, such as facial recognition, medical imaging, object detection, forensic analysis, and security authentication.

In some embodiments, the system may generate the first topology pattern for the first image by determining a vector array based on the first location and the first image characteristic, assigning the vector array an image identifier corresponding to the first image, and storing the vector array in an image index. For example, the system may construct a vector array that represents the detected portion, incorporating data, such as the first location, feature descriptors, distances, angles, and geometric relationships. This vector array serves as a numerical representation of the topology pattern, capturing the structural relationships rather than raw pixel values to ensure efficient storage and retrieval. The system then assigns an image identifier to the vector array, linking it directly to the first image to maintain a reference for future matching and analysis. Once the vector array is generated, the system stores it in an image index, a structured database that allows for fast searching, retrieval, and comparison of topology patterns. By indexing the vector representation instead of the raw image, the system enhances privacy, scalability, and computational efficiency, allowing for quick matching against new images without exposing sensitive visual content.

In some embodiments, the system may generate the first topology pattern for the first image by dividing the first image into a plurality of equal-spaced and equal-size portions and determining a subset of the plurality of equal-spaced and equal-size portions comprising a respective image characteristic. For example, the system may generate a first topology pattern for the first image by first dividing the image into a plurality of equal-spaced and equal-size portions, creating a structured grid that allows for consistent feature extraction. This segmentation ensures that each portion is analyzed independently while maintaining uniformity across different images, making the topology pattern more robust to variations in scale, orientation, and distortion. After processing all portions, the system identifies a subset of portions that contain meaningful characteristics, filtering out sections with insignificant or repetitive patterns. The selected portions form the basis of the first topology pattern, as their relative locations, distances, angles, and geometric relationships are mapped to define the image's structural composition. This subset of portions is then encoded into a numerical array or vector representation, preserving the spatial organization while discarding unnecessary pixel-level details. By using this grid-based segmentation and structured feature selection, the system ensures that the topology pattern remains consistent and comparable across different images, even if the images have variations in lighting, orientation, or partial occlusion. The resulting topology pattern is then stored in an index for future comparison, classification, or recognition, making it highly effective in applications such as biometric authentication, medical imaging, object detection, and forensic analysis, where structural consistency is crucial for accurate identification.

In some embodiments, the system may generate the first topology pattern for the first image by dividing the first image into a plurality of portions, processing each of the plurality of portions for a respective portion pattern, and determining that the first portion in the first image comprises the first image characteristic based determining that the first portion comprises the respective portion pattern. For example, the system may generate the first topology pattern for the first image by dividing the image into a plurality of portions, analyzing each portion individually for distinct patterns, and identifying key portions that contain meaningful characteristics. The process may begin by segmenting the image into multiple regions, ensuring that each portion is small enough to capture local details while still retaining spatial context. This segmentation may be performed using grid-based partitioning, adaptive region segmentation, or feature-driven clustering techniques. Once the image is divided, the system processes each portion independently to extract a respective portion pattern. The system then determines that a first portion in the first image contains a first image characteristic by analyzing its portion pattern and comparing it to predefined criteria or learned feature representations. If the portion pattern meets a certain threshold of uniqueness or relevance, the system confirms that the first portion contains a significant characteristic and includes it in the first topology pattern. This process is repeated for all portions, with only the relevant portions being selected for inclusion in the topology pattern. The final first topology pattern may be generated by encoding the spatial relationships between the selected portions into a numerical vector array or graph-based representation. This ensures that the system captures the structural composition of the image rather than pixel-level details, making the representation robust to distortions, scaling, rotation, and occlusions. The resulting topology pattern is then stored and indexed for later comparison, allowing for efficient recognition in applications such as biometric authentication, forensic analysis, medical diagnostics, and object tracking.

In some embodiments, the system may generate the first topology pattern for the first image by dividing the first image into a plurality of portions, receiving a user resolution setting, generating portion clusters based on the user resolution setting, processing each of the portion clusters for a portion pattern, and determining that the first portion in the first image comprises the first image characteristic based determining that the first portion corresponds to a portion cluster comprising the portion pattern. For example, the system may generate the first topology pattern for the first image by dynamically dividing the image into a plurality of portions, clustering them based on a user-defined resolution setting, and analyzing each cluster to identify relevant image characteristics. The process may begin with the system segmenting the image into multiple portions, where the granularity of segmentation is influenced by the user resolution setting. A higher resolution setting results in smaller, more detailed portions, while a lower resolution setting groups larger areas together, optimizing processing efficiency based on user preferences or system constraints. Once the image is divided, the system creates portion clusters based on the resolution setting, grouping portions that share spatial proximity, similar textures, or feature consistency. These clusters serve as the basis for analyzing local image patterns, reducing redundant processing and improving efficiency. To determine whether a first portion in the first image comprises a first image characteristic, the system checks whether the first portion corresponds to a portion cluster containing a significant portion pattern. If a match is found, the first portion is included in the first topology pattern, preserving its spatial relationship and significance within the image. The system continues this process for all portion clusters, generating a structured representation of the image that encodes relative distances, angles, transformations, and feature locations. The final first topology pattern is then stored in a numerical vector or graph format, making it suitable for efficient image recognition, pattern matching, and anomaly detection.

At step 406, process 400 (e.g., using one or more components described above) compares the topology pattern to a plurality of index topology patterns. For example, the system may compare the first topology pattern to a plurality of index topology patterns. The system may compare the first topology pattern to a plurality of index topology patterns by using mathematical similarity measurements and feature-matching algorithms to determine the closest match. Once the first topology pattern is generated from the first image, the system retrieves a database of indexed topology patterns, each representing preprocessed reference images. The system then applies vector-based comparison methods, such as Euclidean distance, cosine similarity, or Mahalanobis distance, to measure how closely the numerical representation of the first topology pattern aligns with those stored in the index. To account for variations such as scaling, rotation, and perspective shifts, the system may use affine transformations and homography adjustments to normalize the first topology pattern before comparison. Feature-matching algorithms like FLANN (Fast Library for Approximate Nearest Neighbors) or BFMatcher (Brute Force Matcher) are used to identify corresponding structural relationships between the first topology pattern and indexed patterns. If a machine learning approach is integrated, convolutional neural networks (CNNs) or graph-based neural networks (GNNs) can be employed to recognize patterns even when partial distortions or occlusions are present.

In some embodiments, the system may compare the first topology pattern to the plurality of index topology patterns by receiving a first normalization condition and normalizing the first topology pattern by modifying the first topology pattern while maintaining a relationship between the first location and a second location of a second portion in the first image determined to comprise a second image characteristic. For example, the system may compare the first topology pattern to a plurality of index topology patterns by first receiving a first normalization condition and applying transformations to standardize the topology pattern while preserving the spatial relationships between key portions. The first normalization condition may include adjustments for scaling, rotation, translation, skew correction, or perspective alignment, ensuring that the topology pattern remains consistent and comparable across different images regardless of variations in how the image was captured. To achieve normalization, the system first identifies the first location of a first portion in the image and the second location of a second portion, both containing distinct image characteristics. These portions serve as anchor points, defining the structural framework of the topology pattern. The system then applies normalization techniques, such as affine transformations, homography transformations, or feature-based alignment, to modify the first topology pattern while keeping the relative positions, distances, and angles between portions intact. This ensures that the geometric relationships remain stable even if the image has undergone size changes, rotations, or perspective distortions.

After normalization, the system converts the adjusted topology pattern into a numerical representation, such as a vector array, adjacency matrix, or graph-based structure, and proceeds to compare it against the indexed topology patterns stored in a database. The system uses similarity metrics such as Euclidean distance, cosine similarity, or structural similarity index (SSI) to quantify how closely the normalized topology pattern matches with indexed patterns. If machine learning is involved, convolutional neural networks (CNNs) or graph neural networks (GNNs) may refine the comparison by recognizing invariant structural relationships across images. By modifying the topology pattern according to normalization conditions while preserving inter-feature relationships, the system ensures robust and accurate matching even in cases where the image is distorted, resized, or captured from a different angle.

In some embodiments, the system may compare the first topology pattern to the plurality of index topology patterns by receiving a first normalization condition and normalizing the first topology pattern by scaling the first topology pattern while maintaining a relationship between the first location and a second location of a second portion in the first image determined to comprise a second image characteristic. To normalize the topology pattern, the system scales the pattern according to the first normalization condition, ensuring that the relative distances and proportionality between the first and second locations remain consistent. This process may involve multiplying coordinate values by a scaling factor, adjusting the vector representation, or applying geometric transformations, such as affine scaling to ensure that the topology pattern aligns with standardized dimensions used for indexing and comparison. The system ensures that scaling is applied uniformly so that all portions maintain their original spatial relationships, preventing distortion or misalignment. After normalization, the system converts the scaled topology pattern into a vector-based representation, making it compatible with a plurality of index topology patterns stored in a database.

In some embodiments, the system may compare the first topology pattern to the plurality of index topology patterns by dividing the first topology pattern into a plurality of topology pattern portions, and comparing the plurality of topology pattern portions to portions of the plurality of index topology patterns. For example, A system compares the first topology pattern to a plurality of index topology patterns by dividing the first topology pattern into multiple topology pattern portions and then performing a localized comparison against corresponding portions of the indexed topology patterns. This method enhances accuracy by allowing the system to match individual structural components rather than relying solely on a global similarity measure. The process begins by analyzing the first topology pattern, which represents the structural relationships of key portions extracted from the first image. The system then segments the topology pattern into a plurality of topology pattern portions, ensuring that each portion represents a distinct local feature or sub-structure within the overall pattern. The segmentation can be grid-based, hierarchical, or feature-driven, depending on the complexity of the image and the system's application.

Once divided, each topology pattern portion is compared independently to corresponding portions of indexed topology patterns stored in a database. By matching and scoring each portion individually, the system can identify partial matches even when the first image is incomplete, distorted, or contains occlusions. The system then aggregates the similarity scores of all portions to determine an overall confidence score, which reflects how closely the first topology pattern aligns with an indexed topology pattern. This portion-based comparison method improves robustness and flexibility, making it highly effective for applications such as facial recognition (matching partial facial features), object detection (identifying sub-parts of an object), medical imaging (analyzing localized anomalies), and forensic investigations (matching incomplete evidence to known patterns). By focusing on localized comparisons, the system ensures more granular and accurate recognition, even when images are scaled, rotated, or partially obstructed.

In some embodiments, the system may compare the first topology pattern to the plurality of index topology patterns by determining a first tolerance zone for the first topology pattern and excluding portions of the plurality of index topology patterns outside the first tolerance zone. For example, the system may compares the first topology pattern to a plurality of index topology patterns by establishing a first tolerance zone around the first topology pattern and excluding portions of the index topology patterns that fall outside this defined zone. This process enhances efficiency and accuracy by focusing comparisons on relevant structural features while filtering out areas that are unlikely to contribute to a valid match. The process begins with the system generating the first topology pattern, which captures the spatial relationships between significant portions of the first image. To improve matching accuracy, the system then defines a tolerance zone, which serves as a boundary around the first topology pattern to account for minor variations in position, scaling, rotation, or distortions. This tolerance zone is determined based on predefined parameters, statistical thresholds, or machine learning-based adaptive margins, ensuring that slight deviations in the pattern do not result in false negatives.

Once the tolerance zone is defined, the system may evaluate the plurality of index topology patterns and excludes portions that fall outside the tolerance zone. This exclusion process eliminates irrelevant data, allowing the system to focus only on indexed topology patterns that share a meaningful structural similarity with the first topology pattern. By applying a tolerance zone, the system improves robustness against minor distortions, partial occlusions, or slight positional variations, ensuring that valid matches are not rejected due to insignificant differences. Additionally, this approach significantly reduces computational overhead, as it prevents unnecessary comparisons against index topology patterns that are structurally too different from the first topology pattern.

At step 408, process 400 (e.g., using one or more components described above) determines a confidence that the content corresponds to indexed content. For example, the system may, based on comparing the first topology pattern to the plurality of index topology patterns, determine a confidence that the first image corresponds to an index image. The system may determine a confidence level that the first image corresponds to an index image by analyzing the degree of similarity between the first topology pattern and the plurality of index topology patterns using statistical and/or machine learning-based comparison techniques. For example, after extracting and/or normalizing the first topology pattern, the system compares it against indexed topology patterns stored in a database, measuring how well the spatial relationships, distances, angles, and transformations align between the two.

To quantify confidence, the system may apply similarity metrics such as Euclidean distance, cosine similarity, or Mahalanobis distance, which calculate how closely the numerical vector representation of the first topology pattern aligns with those of the indexed patterns. If a feature-matching approach is used, the system determines the number of corresponding key points between the patterns and assigns a similarity score based on the proportion of matching features. Additionally, machine learning models like convolutional neural networks (CNNs) or graph neural networks (GNNs) can further refine the confidence score by learning complex structural relationships and assigning probabilistic values to potential matches.

In some embodiments, the system may then aggregate the confidence scores from different comparison methods and applies thresholding techniques to determine whether the first image strongly, moderately, or weakly corresponds to an indexed image. If the confidence score exceeds a predefined threshold, the system confirms a match and may generate a recommendation, alert, or classification result. If the score is borderline or ambiguous, the system may prompt for manual review, reprocessing, and/or additional verification. For example, the system may aggregate the confidence scores from different comparison methods and applies thresholding techniques to classify the strength of the match between the first image and an indexed image. This process begins with the system evaluating the first topology pattern against a plurality of indexed topology patterns, using various feature-matching algorithms, similarity metrics, and machine learning models to generate individual confidence scores. Once these confidence scores are computed, the system aggregates them by applying weighted averaging, statistical fusion, or machine learning-based ensemble techniques to produce a final confidence score. This score may then be compared against predefined threshold ranges to determine the match strength. If the confidence score exceeds the highest threshold, the system confirms a high-confidence match and may automatically generate a recommendation, classification, or alert without further review. If the score falls within a middle range, the system may flag the match as potentially correct but requiring secondary validation, depending on the application's sensitivity. If the score is borderline or ambiguous, the system may prompt for manual review, reprocessing, or additional verification to prevent false positives or negatives. This may include requesting higher-resolution data, refining feature extraction, or incorporating contextual metadata to improve decision-making.

In some embodiments, the system may determine the confidence that the first image corresponds to the index image by determining a similarity between the first topology pattern and an index topology pattern corresponding to the index image and using the similarity to determine the confidence. To measure similarity, the system applies feature-matching algorithms, statistical similarity metrics, or machine learning models to compare the two topology patterns. Common techniques include Euclidean distance, cosine similarity, Mahalanobis distance, or graph-based structural comparisons, which quantify how closely the two patterns align in terms of relative distances, angles, and transformations. Once the similarity is calculated, the system uses it to generate a confidence score, reflecting the likelihood that the first image corresponds to the indexed image. Higher similarity values correspond to higher confidence, while lower values indicate weaker matches. The system then applies thresholding techniques to categorize the match into strong, moderate, or weak confidence levels. If the confidence score surpasses a predefined match threshold, the system confirms the correspondence and may generate a recommendation, classification, or alert. If the score falls within an ambiguous range, the system may prompt for manual review or request additional data for verification.

In some embodiments, the system may determine the confidence that the first image corresponds to the index image by determining a number of portions in the first topology pattern that correspond to portions in an index topology pattern corresponding to the index image and using the number of portions to determine the confidence. For example, the system may count the number of matching portions and uses this count as a quantitative measure of similarity between the two images. Using the number of matched portions, the system assigns a confidence score that reflects the degree of correspondence between the first image and the indexed image. If the number of matching portions exceeds a predefined threshold, the system categorizes the match as high confidence and may generate a recommendation, classification, or alert confirming the match. If the number of matched portions falls within a borderline range, the system may flag the match as moderate confidence, prompting further manual review or secondary verification. If the count is too low, the system may classify the match as low confidence and reject the correspondence. By using a portion-based matching approach, the system ensures robust recognition, even when partial occlusions, distortions, or variations exist in the first image

In some embodiments, the system may determine the confidence that the first image corresponds to the index image by determining a number of portions in the first topology pattern that do not correspond to portions in an index topology pattern corresponding to the index image and comparing the number of portions to a threshold number. For example, the system may count the number of non-matching portions and compares this value to a predefined threshold. If the number of non-matching portions is low, the system assigns a high confidence score, confirming a strong correspondence between the first image and the indexed image. If the number of non-matching portions falls within a borderline range, the system assigns a moderate confidence score, potentially triggering manual review or additional verification before finalizing the match. However, if the number of non-matching portions exceeds the threshold, the system lowers the confidence score or rejects the match, concluding that the first image does not correspond closely enough to the indexed image. By incorporating non-matching portion analysis, the system enhances accuracy and robustness, reducing false positives and ensuring reliable image comparison even in cases where partial occlusions, distortions, or variations exist.

In some embodiments, the system may determine the confidence that the first image corresponds to the index image by determining an overlap percentage between the first topology pattern and an index topology pattern corresponding to the index image and determining the confidence based on the overlap percentage. For example, the system may calculate the ratio of the number of matched portions to the total number of portions in the first topology pattern and expresses this ratio as a percentage. This overlap percentage represents the degree of similarity between the two patterns. If the overlap percentage is high (e.g., above 80-90%), the system assigns a high confidence score, confirming a strong match between the first image and the indexed image. If the overlap percentage is moderate (e.g., 50-79%), the system assigns a medium confidence score, suggesting a possible match but requiring additional verification, such as manual review or supplemental processing. If the overlap percentage is low (e.g., below 50%), the system assigns a low confidence score and may reject the match, determining that the first image does not sufficiently correspond to the indexed image. By using overlap percentage analysis, the system ensures a quantifiable and threshold-based approach to matching images while accounting for partial occlusions, distortions, or transformations.

At step 410, process 400 (e.g., using one or more components described above) generates a recommendation based on the confidence. For example, the system may generate for display, on a user interface, a recommendation based on the confidence. The system may generate a recommendation for display on a user interface (UI) based on the confidence level by structuring and presenting the comparison results in a clear and interpretable manner. Once the system determines a confidence score indicating how well the first image matches an indexed image, the system may format the data into a visual and interactive output that allows the user to quickly assess the recommendation. The UI may display the first image and the closest-matching index image side by side, along with a confidence percentage or similarity score that quantifies the likelihood of a match.

To enhance usability, the system may provide highlighted key points, bounding boxes, or overlays that indicate specific features contributing to the match, such as facial landmarks in biometric recognition or structural similarities in object detection. If multiple potential matches exist, the UI can present a ranked list of candidates, sorted by confidence level, allowing users to select the most relevant result. Additionally, the UI may include metadata such as timestamps, classification labels, or contextual information about the indexed image to provide further insights.

In some embodiments, in cases where the confidence level is borderline or uncertain, the UI may generate a review prompt suggesting further verification steps, such as manual inspection, additional data input, or multi-factor authentication. Interactive elements like buttons for approval, rejection, or requesting further analysis can also be included to facilitate user decision-making. By structuring the recommendation in an intuitive and user-friendly manner, the system ensures that users can effectively interpret and act on the match results, making it valuable for applications such as security screening, forensic analysis, medical diagnostics, inventory tracking, and automated verification systems.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims that follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method for image detection in obscured and/or distorted environments.
2. The method of the preceding embodiment, further comprising: receiving a first image; generating a first topology pattern for the first image based on a first location of a first portion in the first image determined to comprise a first image characteristic; comparing the first topology pattern to a plurality of index topology patterns; based on comparing the first topology pattern to the plurality of index topology patterns, determining a confidence that the first image corresponds to an index image; and generating for display, on a user interface, a recommendation based on the confidence.
3. The method of any one of the preceding embodiments, wherein generating the first topology pattern for the first image further comprises: generating a greyscale version of the first image; and determining the first portion has the first image characteristic based on the greyscale version.
4. The method of any one of the preceding embodiments, wherein generating the first topology pattern for the first image further comprises: determining a second location of a second portion in the first image determined to comprise a second image characteristic; and determining a relationship between the first location and the second location.
5. The method of any one of the preceding embodiments, wherein generating the first topology pattern for the first image further comprises: determining a vector array based on the first location and the first image characteristic; assigning the vector array an image identifier corresponding to the first image; and storing the vector array in an image index.
6. The method of any one of the preceding embodiments, wherein generating the first topology pattern for the first image further comprises: dividing the first image into a plurality of equal-spaced and equal-size portions; and determining a subset of the plurality of equal-spaced and equal-size portions comprising a respective image characteristic.
7. The method of any one of the preceding embodiments, wherein generating the first topology pattern for the first image further comprises: dividing the first image into a plurality of portions; processing each of the plurality of portions for a respective portion pattern; and determining that the first portion in the first image comprises the first image characteristic based determining that the first portion comprises the respective portion pattern.
8. The method of any one of the preceding embodiments, wherein generating the first topology pattern for the first image further comprises: dividing the first image into a plurality of portions; receiving a user resolution setting; generating portion clusters based on the user resolution setting; processing each of the portion clusters for a portion pattern; and determining that the first portion in the first image comprises the first image characteristic based determining that the first portion corresponds to a portion cluster comprising the portion pattern.
9. The method of any one of the preceding embodiments, wherein comparing the first topology pattern to the plurality of index topology patterns comprises: receiving a first normalization condition; and normalizing the first topology pattern by modifying the first topology pattern while maintaining a relationship between the first location and a second location of a second portion in the first image determined to comprise a second image characteristic.
10. The method of any one of the preceding embodiments, wherein comparing the first topology pattern to the plurality of index topology patterns comprises: receiving a first normalization condition; and normalizing the first topology pattern by scaling the first topology pattern while maintaining a relationship between the first location and a second location of a second portion in the first image determined to comprise a second image characteristic.
11. The method of any one of the preceding embodiments, wherein comparing the first topology pattern to the plurality of index topology patterns comprises: dividing the first topology pattern into a plurality of topology pattern portions; and comparing the plurality of topology pattern portions to portions of the plurality of index topology patterns.
12. The method of any one of the preceding embodiments, wherein comparing the first topology pattern to the plurality of index topology patterns further comprises: determining a first tolerance zone for the first topology pattern; and excluding portions of the plurality of index topology patterns outside the first tolerance zone.
13. The method of any one of the preceding embodiments, wherein determining the confidence that the first image corresponds to the index image further comprises: determining a similarity between the first topology pattern and an index topology pattern corresponding to the index image; and using the similarity to determine the confidence.
14. The method of any one of the preceding embodiments, wherein determining the confidence that the first image corresponds to the index image further comprises: determining a number of portions in the first topology pattern that correspond to portions in an index topology pattern corresponding to the index image; and using the number of portions to determine the confidence.
15. The method of any one of the preceding embodiments, wherein determining the confidence that the first image corresponds to the index image further comprises: determining a number of portions in the first topology pattern that do not correspond to portions in an index topology pattern corresponding to the index image; and comparing the number of portions to a threshold number.
16. One or more non-transitory, computer-readable mediums storing instructions that, when executed by a data processing apparatus, cause the data processing apparatus to perform operations comprising those of any of embodiments 1-15.
17. A system comprising one or more processors; and memory storing instructions that, when executed by the processors, cause the processors to effectuate operations comprising those of any of embodiments 1-15.
18. A system comprising means for performing any of embodiments 1-15.

What is claimed is:

1. A system for image detection in obscured or distorted environments, the system comprising:
one or more processors; and
one or more non-transitory, computer-readable mediums comprising instructions that when executed by the one or more processors cause operations comprising:
receiving a plurality of index images for an image index;
retrieving an index image from the plurality of index images;
identifying a plurality of portions in the index image based on one or more respective image characteristics in the plurality of portions;
determining an index topology pattern based on respective locations of the plurality of portions in the index image;
indexing, in the image index, the index topology pattern with an index identifier for the index image, wherein the image index stores a plurality of index topology patterns for the plurality of index images;
receiving, via a user interface, a user submission of a target image;
in response to receiving the user submission, generating a target topology pattern for the target image;
comparing the target topology pattern to the plurality of index topology patterns;
based on comparing the target topology pattern to the plurality of index topology patterns, determining a confidence that the target image corresponds to the index image; and
generating for display, on the user interface, a recommendation based on the confidence.

2. A method for image detection in obscured and/or distorted environments, the method comprising:
receiving a first image;
generating a first topology pattern for the first image based on a first location of a first portion in the first image determined to comprise a first image characteristic;
comparing the first topology pattern to a plurality of index topology patterns;
based on comparing the first topology pattern to the plurality of index topology patterns, determining a confidence that the first image corresponds to an index image; and
generating for display, on a user interface, a recommendation based on the confidence.

3. The method of claim 2, wherein generating the first topology pattern for the first image further comprises:
generating a greyscale version of the first image; and
determining the first portion has the first image characteristic based on the greyscale version.

4. The method of claim 2, wherein generating the first topology pattern for the first image further comprises:
determining a second location of a second portion in the first image determined to comprise a second image characteristic; and
determining a relationship between the first location and the second location.

5. The method of claim 2, wherein generating the first topology pattern for the first image further comprises:
determining a vector array based on the first location and the first image characteristic;
assigning the vector array an image identifier corresponding to the first image; and
storing the vector array in an image index.

6. The method of claim 2, wherein generating the first topology pattern for the first image further comprises:
dividing the first image into a plurality of equal-spaced and equal-size portions; and
determining a subset of the plurality of equal-spaced and equal-size portions comprising a respective image characteristic.

7. The method of claim 2, wherein generating the first topology pattern for the first image further comprises:
dividing the first image into a plurality of portions;
processing each of the plurality of portions for a respective portion pattern; and
determining that the first portion in the first image comprises the first image characteristic based determining that the first portion comprises the respective portion pattern.

8. The method of claim 2, wherein generating the first topology pattern for the first image further comprises:
dividing the first image into a plurality of portions;
receiving a user resolution setting;
generating portion clusters based on the user resolution setting;
processing each of the portion clusters for a portion pattern; and
determining that the first portion in the first image comprises the first image characteristic based determining that the first portion corresponds to a portion cluster comprising the portion pattern.

9. The method of claim 2, wherein comparing the first topology pattern to the plurality of index topology patterns comprises:
receiving a first normalization condition; and
normalizing the first topology pattern by modifying the first topology pattern while maintaining a relationship between the first location and a second location of a second portion in the first image determined to comprise a second image characteristic.

10. The method of claim 2, wherein comparing the first topology pattern to the plurality of index topology patterns comprises:
receiving a first normalization condition; and
normalizing the first topology pattern by scaling the first topology pattern while maintaining a relationship between the first location and a second location of a second portion in the first image determined to comprise a second image characteristic.

11. The method of claim 2, wherein comparing the first topology pattern to the plurality of index topology patterns comprises:
dividing the first topology pattern into a plurality of topology pattern portions; and
comparing the plurality of topology pattern portions to portions of the plurality of index topology patterns.

12. The method of claim 2, wherein comparing the first topology pattern to the plurality of index topology patterns further comprises:
determining a first tolerance zone for the first topology pattern; and
excluding portions of the plurality of index topology patterns outside the first tolerance zone.

13. The method of claim 2, wherein determining the confidence that the first image corresponds to the index image further comprises:
determining a similarity between the first topology pattern and an index topology pattern corresponding to the index image; and
using the similarity to determine the confidence.

14. The method of claim 2, wherein determining the confidence that the first image corresponds to the index image further comprises:
determining a number of portions in the first topology pattern that correspond to portions in an index topology pattern corresponding to the index image; and
using the number of portions to determine the confidence.

15. The method of claim 2, wherein determining the confidence that the first image corresponds to the index image further comprises:
determining a number of portions in the first topology pattern that do not correspond to portions in an index topology pattern corresponding to the index image; and
comparing the number of portions to a threshold number.

16. The method of claim 2, wherein determining the confidence that the first image corresponds to the index image further comprises:
determining an overlap percentage between the first topology pattern and an index topology pattern corresponding to the index image; and
determining the confidence based on the overlap percentage.

17. One or more non-transitory, computer-readable mediums comprising instructions that when executed by one or more processors cause operations comprising:
receiving a plurality of index images for an image index;
retrieving an index image from the plurality of index images;
identifying a plurality of portions in the index image based on one or more respective image characteristics in the plurality of portions;
determining an index topology pattern based on respective locations of the plurality of portions in the index image; and
indexing, in the image index, the index topology pattern with an index identifier for the index image, wherein the image index stores a plurality of index topology patterns for the plurality of index images.

18. The one or more non-transitory, computer-readable mediums of claim 17, wherein determining the index topology pattern based on the respective locations of the plurality of portions in the index image further comprises:
determining a vector array based on the respective locations; and
assigning the vector array an image identifier corresponding to the index image.

19. The one or more non-transitory, computer-readable mediums of claim 17, wherein determining the index topology pattern based on the respective locations of the plurality of portions in the index image further comprises:
dividing the index image into a plurality of equal-spaced and equal-size portions;
determining a subset of the plurality of equal-spaced and equal-size portions comprising a respective image characteristic; and
determining the respective locations of the plurality of portions based on locations of the subset.

20. The one or more non-transitory, computer-readable mediums of claim 17, wherein determining the index topology pattern based on the respective locations of the plurality of portions in the index image further comprises:
determining that each of the plurality of portions comprises a respective portion pattern; and
determining the respective locations of the plurality of portions in response to determining that each of the plurality of portions comprises the respective portion pattern.
